(19) United States
(12) Patent Application Publication
(10) Pub. No.: US 2025/0299485 A1
(43) Pub. Date: Sep. 25, 2025

(54) MULTI-OBJECT TRACKING USING HIERARCHICAL GRAPH NEURAL NETWORKS

(71) Applicant: NVIDIA Corporation, Santa Clara, CA (US)

(72) Inventors: Ibrahim Orcun Cetintas, Munich (DE); Tim Meinhardt, Munich (DE); Guillem Braso Andilla, San Francisco, CA (US); Laura Leal-Taixe, Florence (IT)

(21) Appl. No.: 19/064,184

(22) Filed: Feb. 26, 2025

Related U.S. Application Data
(60) Provisional application No. 63/568,976, filed on Mar. 22, 2024.

(30) Foreign Application Priority Data
Dec. 17, 2024 (IT) 102024000028797

(51) Int. Cl. G06V 20/40; G06V 10/776; G06V 10/82

(52) U.S. Cl. CPC G06V 20/41; G06V 10/776; G06V 10/82

(57) ABSTRACT

Various examples, systems, and methods are disclosed relating to dynamic novel view reconstruction based at least in part on flow rematching. A first computing system can update a graph neural network based at least on video data representing a plurality of first objects and a plurality of first labels corresponding to the plurality of first objects. The first computing system can cause the graph neural network to generate a plurality of second labels of a first example video and update the graph neural network based at least on the plurality of second labels and the first example video. The first computing system can cause the graph neural network to generate a plurality of third labels of a second example video. The first computing system can output a request for a modification to the at least one third label responsive to the uncertainty score satisfying an annotation criterion.

### CROSS-REFERENCE TO RELATED PATENT APPLICATIONS

This application claims the benefit of and priority to Italian Patent Application No. 102024000028797, filed Dec. 17, 2024, and claims the benefit of U.S. Provisional Application No. 63/568,976, filed Mar. 22, 2024, the contents of both of which are hereby incorporated by reference in their entirety.

### BACKGROUND

Improving the accuracy and performance of multi-object tracking in video data presents challenges. Some traditional methods rely on manual annotation and single-object tracking models, leading to inefficiencies and limited scalability. This approach can result in inadequate tracking performance. Current systems are inadequate at capturing complex relationships between objects across frames, requiring manual intervention to maintain accuracy. Additionally, some traditional methods rely on large-scale annotated datasets, leading to inefficiencies and increased resource demands. This approach can result in redundant processing and a failure to manage dense temporal data. Current methods are inadequate for handling multiple objects across frames, which increases the complexity of tracking over time. Challenges in implementing neural networks for multi-object tracking create inefficiencies, affecting the accuracy and computational efficiency of tracking in dynamic, multi-object environments (e.g., real-time or near real-time applications).

### SUMMARY

Implementations of the present disclosure relate to systems and methods for improving multi-object tracking in video data using hierarchical graph neural networks. Systems and methods are disclosed that can utilize machine learning models, such as hierarchical graph neural networks, combined with synthetic pre-training and pseudo-labeling to track objects across multiple frames. This can reduce manual annotation by directing computational resources towards refining associations between objects in video data over time. For example, systems and methods in accordance with the present disclosure can generate labels for objects detected in video frames and refine these labels to represent predicted associations between objects across frames.

Additionally, the systems and methods can adjust tracking criteria based at least on one or more metrics such as—for example and without limitation—object association confidence, entropy, or other probabilistic measures, guiding annotation efforts towards uncertain or complex associations. By selectively presenting outputs for manual intervention based at least on one or more of these uncertainty metrics, the systems and methods can improve tracking operations while reducing manual annotation efforts. In some implementations, hierarchical processing allows the system to manage different levels of tracking (e.g., initial object detection and/or refining predicted associations between objects across multiple frames). The dynamic refinement process can improve the performance of multi-object tracking systems in real-time (or near real-time) applications.

Some implementations relate to one or more processors including processing circuitry. The processing circuitry updates a graph neural network based at least on video data representing a plurality of first objects and a plurality of first labels corresponding to the plurality of first objects. The processing circuitry causes the graph neural network to generate a plurality of second labels of a first example video and update the graph neural network based at least on the plurality of second labels and the first example video. The processing circuitry causes the graph neural network to generate a plurality of third labels of a second example video. In some implementations, at least one third label of the plurality of third labels corresponds to an uncertainty score. The processing circuitry outputs a request for a modification to the at least one third label responsive to the uncertainty score satisfying an annotation criterion.

In some implementations, the plurality of second labels correspond to one or more predicted associations between a plurality of second objects in a plurality of frames of the first example video. In some implementations, the plurality of third labels correspond to one or more predicted associations between a plurality of third objects across a plurality of frames of the second example video. In some implementations, the graph neural network is configured to generate a graph representation of the second example video including a plurality of nodes and a plurality of edges.

In some implementations, the plurality of nodes represent a plurality of detections of the plurality of third objects across the plurality of frames and the plurality of edges represent the one or more predicted associations. In some implementations, at least one edge of the plurality of edges is associated with at least one corresponding label of the plurality of third labels. In some implementations, the request for modification includes a plurality of selectable actions for modifying the at least one third label. In some implementations, the plurality of selectable actions include at least one of an action to confirm a validity of at least one of the one or more predicted associations between at least two detections of the plurality of detections, an action to remove at least one detection of the plurality of detections, an action to modify one or more spatial boundaries of a bounding box of the at least one detection, or an action to associate the at least one detection in a first frame of the plurality of frames to another detection in a second frame of the plurality of frames.

In some implementations, the uncertainty score of the plurality of third labels is based at least on an entropy level (expressed as a determined or predicted entropy amount, value, or other representation, in one or more example embodiments) or at least one probabilistic metric derived from an output of the graph neural network. In some implementations, the entropy level corresponds to a measure of uncertainty in the one or more predicted associations of the plurality of third objects across the plurality of frames. In some implementations, the video data includes a plurality of synthetic data samples corresponding to a plurality of simulated trajectories of the plurality of first objects in a plurality of environments. In some implementations, updating the graph neural network includes using the plurality of synthetic data samples to pre-train the graph neural network to generate the plurality of second labels of the first example video.

In some implementations, the annotation criterion corresponds to a threshold for selecting a subset of the plurality of third labels having corresponding uncertainty scores satisfying the threshold. In some implementations, the graph neural network includes a hierarchical structure configured to model a plurality of detection candidates. In some implementations, a first level of the hierarchical structure includes generating at least one label for at least one detection candidate of the plurality of detection candidates. In some implementations, one or more subsequent levels of the hierarchical structure includes generating at least one label for one or more predicted associations between the plurality of detection candidates. In some implementations, the video data includes data captured using a plurality of cameras positioned in an environment. In some implementations, the graph neural network includes performing a two-dimensional (2D) to three-dimensional (3D) transformation on the second example video.

Some implementations relate to a system. The system can include one or more processors to execute operations including operations to update a graph neural network based at least on video data representing a plurality of first objects and a plurality of first labels corresponding to the plurality of first objects. The system can include one or more processors to execute operations including operations to cause the graph neural network to generate a plurality of second labels of a first example video and update the graph neural network based at least on the plurality of second labels and the first example video. The system can include one or more processors to execute operations including operations to cause the graph neural network to generate a plurality of third labels of a second example video. In some implementations, at least one third label of the plurality of third labels correspond to an uncertainty value. The system can include one or more processors to execute operations including operations to output a request for a modification to the at least one third label responsive to the uncertainty value satisfying an annotation criterion.

In some implementations, the plurality of second labels correspond to one or more predicted associations between a plurality of second objects in a plurality of frames of the first example video. In some implementations, the plurality of third labels correspond to one or more predicted associations between a plurality of third objects across a plurality of frames of the second example video. In some implementations, the graph neural network is configured to generate a graph representation of the second example video including a plurality of nodes and a plurality of edges.

In some implementations, the plurality of nodes represent a plurality of detections of the plurality of third objects across the plurality of frames and the plurality of edges represent the one or more predicted associations. In some implementations, at least one edge of the plurality of edges is associated with a corresponding label of the plurality of third labels. In some implementations, the request for modification includes a plurality of selectable actions for modifying the at least one third label. In some implementations, the plurality of selectable actions including at least one of one or more actions to confirm a validity of at least one of the one or more predicted associations between at least two detections of the plurality of detections, one or more actions to remove at least one detection of the plurality of detections, one or more actions to confirm one or more spatial boundaries of a bounding box of the at least one detection, or one or more actions to associate the at least one detection in a first frame of the plurality of frames to another detection in a second frame of the plurality of frames.

In some implementations, the uncertainty value of the plurality of third labels is based at least on an entropy value or at least one probabilistic metric derived from an output of the graph neural network. In some implementations, the entropy value corresponds to a measure of uncertainty in the one or more predicted associations of the plurality of third objects across the plurality of frames. In some implementations, the video data includes a plurality of synthetic data samples corresponding to a plurality of simulated trajectories of the plurality of first objects in a plurality of environments. In some implementations, updating the graph neural network includes using the plurality of synthetic data samples to pre-train the graph neural network to generate the plurality of second labels of the first example video.

Some implementations relate to a method. The method includes updating, using one or more processors, a graph neural network based at least on video data representing a plurality of first objects and a plurality of first labels corresponding to the plurality of first objects. The method includes causing, using the one or more processors, the graph neural network to generate a plurality of second labels of a first example video and update the graph neural network based at least on the plurality of second labels and the first example video. The method includes causing, using the one or more processors, the graph neural network to generate a plurality of third labels of a second example video. In some implementations, at least one third label of the plurality of third labels corresponds to an uncertainty value. The method includes outputting, using the one or more processors, a request for a modification to the at least one third label responsive to the uncertainty value satisfying an annotation criterion.

The processors, systems, and/or methods described herein can be implemented by or included in at least one a system. The system can include a perception system for an autonomous or semi-autonomous machine. The system can include a system for performing simulation operations. The system can include a system for performing digital twin operations. The system can include a system for performing light transport simulation. The system can include a system for performing collaborative content creation for 3D assets. The system can include a system for performing deep learning operations. The system can include a system for performing remote operations. The system can include a system for performing real-time streaming. The system can include a system for generating or presenting one or more of augmented reality content, virtual reality content, or mixed reality content. The system can include a system implemented using an edge device. The system can include a system implemented using a robot. The system can include a system for performing conversational AI operations. The system can include a system implementing one or more multi-model language models. The system can include a system implementing one or more large language models (LLMs). The system can include a system implementing one or more small language models (SLMs). The system can include a system implementing one or more vision language models (VLMs). The system can include a system for generating synthetic data. The system can include a system for generating synthetic data using AI. The system can include a system incorporating one or more virtual machines (VMs). The system can include a system implemented at least partially in a data center. The system can include a system implemented at least partially using cloud computing resources.

### BRIEF DESCRIPTION OF THE DRAWINGS

The present systems and methods for multi-object tracking using hierarchical graph neural networks in an object tracking pipeline are described in detail below with reference to the attached drawing figures, wherein:

FIG. 1 is a block diagram of an example of a system, in accordance with some implementations of the present disclosure;

FIG. 2 is a flow diagram of an example of a method for multi-object tracking in an object tracking pipeline, in accordance with some implementations of the present disclosure;

FIG. 3A is an example multi-stage training process including any one or more synthetic pretraining, training with pseudo-labels, and active learning, in accordance with some implementations of the present disclosure;

FIG. 3B is an example system configuration illustrating detection and tracking within a graph neural network (GNN) hierarchy pipeline, in accordance with some implementations of the present disclosure;

FIG. 3C is an example illustration of an annotation process, in accordance with some implementations of the present disclosure;

FIG. 4A is a block diagram of an example generative language model system for use in implementing at least some implementations of the present disclosure;

FIG. 4B is a block diagram of an example generative language model that includes a transformer encoder-decoder for use in implementing at least some implementations of the present disclosure;

FIG. 4C is a block diagram of an example generative language model that includes a decoder-only transformer architecture for use in implementing at least some implementations of the present disclosure;

FIG. 5 is a block diagram of an example computing device for use in implementing at least some implementations of the present disclosure; and

FIG. 6 is a block diagram of an example data center for use in implementing at least some implementations of the present disclosure.

### DETAILED DESCRIPTION

This disclosure relates to systems and methods for multi-object tracking using hierarchical graph neural networks, such as hierarchical graph-based labeling using synthetic pre-training and pseudo-labeling for multi-object tracking. Machine vision systems can perform operations such as detecting and tracking objects. However, it is challenging to perform these tasks for situations such as where tracking multiple objects is useful. For example, some systems rely on increasingly larger amounts of annotated data to facilitate machine learning model training. Annotating image datasets is resource intensive; introducing a temporal component for tracking can further increase the task difficulty and data scale requirements. For example, redundancies between frames can cause the information density to scale insufficiently with the amount of data, which can make the overall annotation task more challenging and resource-intensive. Existing approaches fail to provide high-performance solutions to video labeling in the video domain, such as by ignoring the dense temporal component or limiting the approach to a single object setup.

Systems and methods in accordance with the present disclosure can facilitate higher performance labeling of video data for multi-object tracking, e.g., at a performance level comparable with or greater than manually annotated data, while requiring significantly fewer manual annotations, e.g., three percent to twenty percent manual annotation. The system can use synthetic pre-training of a model, such as a hierarchical graph-based model, which can avoid dependence on an initial well-curated, large-scale dataset. The system can train/retrain the model using pseudo-labels generated on real (e.g., unlabeled) data. The system can use active learning to selectively present one or more outputs of the retrained model for annotation (e.g., by a user); for example, the system can assign an uncertainty score to each output and present a given output for annotation responsive to the uncertainty score exceeding a threshold and/or the given outputs being of a subset of all outputs, e.g., a percentage or fraction having the highest uncertainty score (e.g., three percent highest uncertainty). The system can present the one or more outputs at a track level, rather than frame level, allowing for more efficient annotation.

For example, the system can update the graph neural network by using synthetic pre-training to generate initial labels for objects and then retrain on real video data using pseudo-labels. The system can generate labels for detections at an initial level and refine these labels to represent predicted associations between detections at subsequent levels (e.g., relationships or connections between objects (or their detections) over time). That is, labeling can occur at the track level by generating the labels on the edges to determine continuity of one or more tracks across the plurality of frames of the example video. The system can compute uncertainty scores for the predicted associations using metrics such as entropy and/or entropy value (e.g., uncertainty in association confidence levels) to determine the confidence in these predictions. The system can request modifications for predicted associations that meet a criterion, using uncertainty scores to direct annotation efforts toward areas where the model shows lower confidence. Thus, the system can improve tracking accuracy by generating initial labels for detections and refining predicted associations between detections based at least on one or more uncertainty scores, improving computational resource allocation to associations with higher uncertainty, and reducing computational overhead in multi-object tracking across frames.

In some implementations, the system can generate labels for predicted associations between objects across multiple frames in a video (e.g., video data containing dense temporal components or multi-object occlusions). That is, edges can be elements that include labels, indicating the predicted continuity of an object across multiple frames. For example, the graph neural network can be configured to output a graph representation including nodes and edges. That is, the nodes can represent detections of objects in the video frames, and the edges can represent the predicted associations between these detections. The system can also determine uncertainty scores for the associations using metrics such as entropy and/or entropy value (or at least one probabilistic metric, e.g., metrics indicating model prediction confidence), guiding selective modifications of predicted associations to improve tracking accuracy and reduce computational load. In some implementations, the system can perform hierarchical processing where different levels of the graph neural network can be dedicated to generating labels for detections and refining associations between detections. Additionally, the system can also support multi-view environments (e.g., multiple cameras in different positions) and can transform video data from two-dimensional representations to three-dimensional representations to perform multi-object tracking.

The system can also utilize a combination of synthetic data and real data to optimize the graph neural network (e.g., pre-training with synthetic data simulating varied tracking scenarios), pre-training the model with simulated trajectories and refining it using pseudo-labels generated on real, unlabeled data. The system can employ active learning to emphasize annotation efforts on areas with higher uncertainty (e.g., uncertain edges in the graph representation). Additionally, the system can provide various selectable actions for modifying predicted associations, such as confirming the validity of associations, removing detections, adjusting bounding boxes, and/or associating detections across frames.

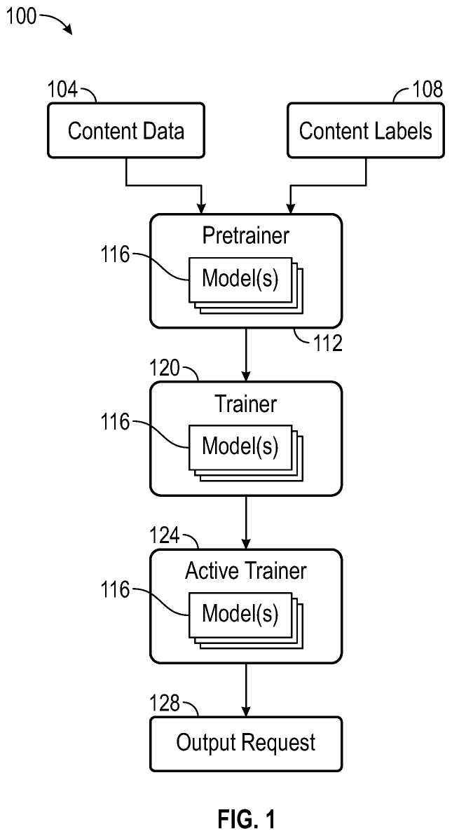

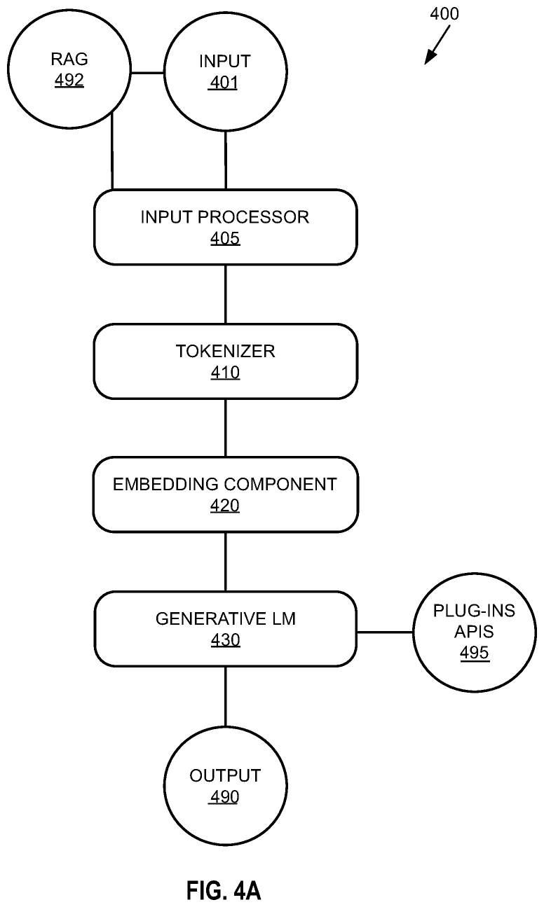

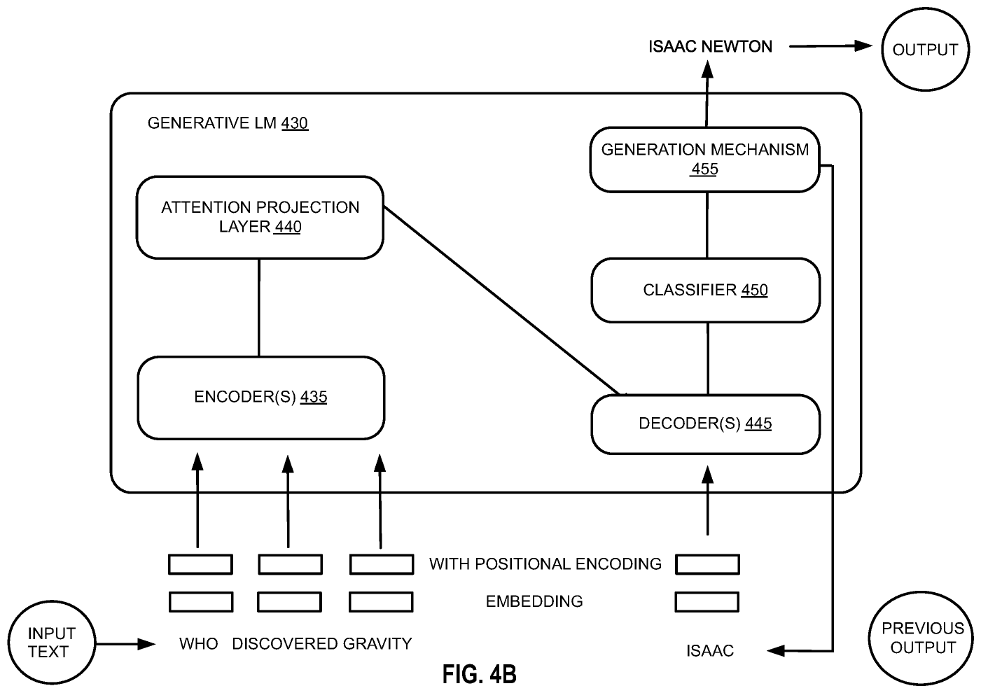

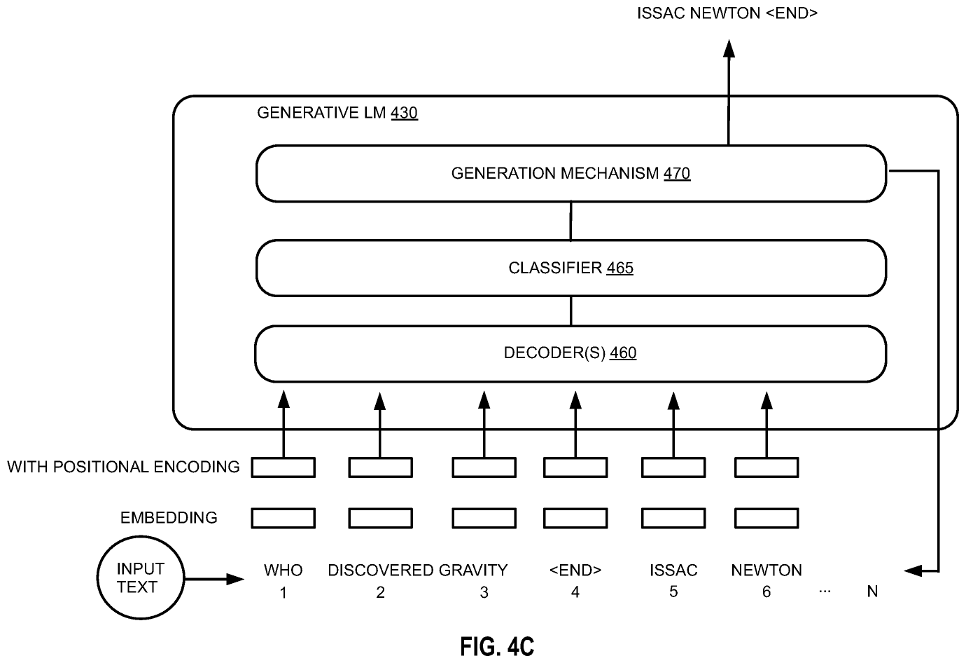

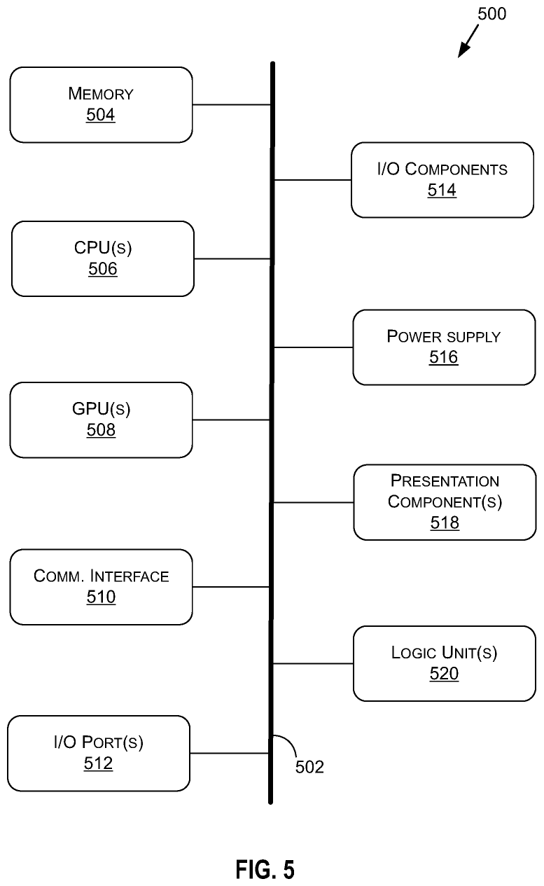

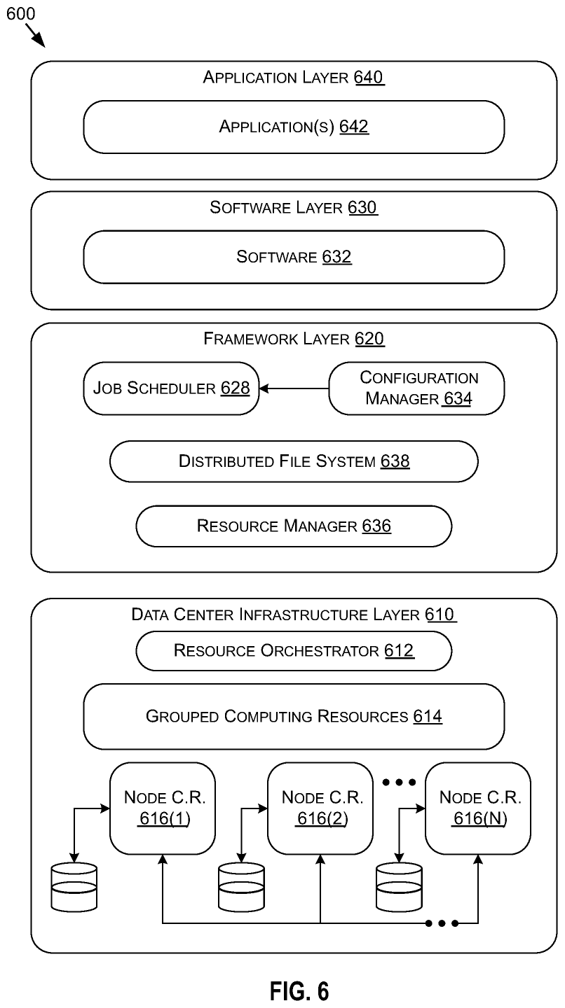

With reference to FIG. 1, FIG. 1 is an example block diagram of a system 100, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 400 of FIG. 4A, example generative language model (LM) 430 of FIGS. 4B-4C, example computing device 500 of FIG. 5, and/or example data center 600 of FIG. 6.

The system 100 can implement at least a portion of an object tracking pipeline, such as a multi-object tracking pipeline, a graph-based tracking pipeline, and/or a video frame analysis pipeline. The system 100 can be used to perform object tracking and/or object association by any of various systems described herein, including but not limited to autonomous vehicle systems, warehouse management systems, surveillance systems, industrial robotics systems, drone-based monitoring systems, augmented reality systems, and/or virtual reality systems.

Generally, the object tracking pipeline can include operations performed by the system 100. For example, the object tracking pipeline can include any one or more of a pretraining stage, a training stage, and/or an active training stage. At least one (e.g., each) stage of the object tracking pipeline can include one or more components of the system 100 that perform the functions described herein. In some implementations, one or more of the stages can be performed during the training of AI models. Additionally, one or more of the stages can be performed during the inference phase using the AI models.

The system 100 (e.g., implementing the object tracking pipeline) can update (e.g., pretraining stage) a graph neural network based at least on video data representing a plurality of first objects and a plurality of first labels corresponding to the plurality of first objects. In some implementations, implementing the object tracking pipeline can include the system 100 causing (e.g., training stage) the graph neural network to generate a plurality of second labels of a first example video and update the graph neural network based at least on the plurality of second labels and the first example video. Additionally, implementing the object tracking pipeline can include the system 100 causing (e.g., active learning stage) the graph neural network to generate a plurality of third labels of a second example video. At least one third label of the plurality of third labels can correspond to an uncertainty score or value. The uncertainty score or value can be a probabilistic metric that indicates the level of confidence the model assigns to prediction outcomes. For example, the uncertainty score can be used to prioritize regions with low confidence for further annotation or refinement. In some implementations, implementing the object tracking pipeline can include the system 100 outputting a request for a modification to the at least one third label responsive to the uncertainty score or value satisfying an annotation criterion. Thus, the graph-based object tracking pipeline can improve the accuracy of object tracking over time by refining uncertain associations and improving the estimations of model 116.

The pretrainer 112, trainer 120, and/or active trainer 124 can include any one or more artificial intelligence models (e.g., machine learning models, supervised models, neural network models, deep neural network models), rules, heuristics, algorithms, functions, or various combinations thereof to perform operations including data augmentation, such as synthetic data generation, pseudo-label creation, and association refinement. That is, model 116 can be a neural network trained to generate object associations across sequential frames in video data. In some implementations, the pretrainer 112 can output synthetic labels (e.g., bounding boxes, object trajectories, object classifications, and/or any data relevant to object tracking). For example, synthetic labels for vehicles moving through various intersections can be generated. In some implementations, the trainer 120 (described in more detail below) can output pseudo-labels (e.g., predicted object associations, predicted object positions, predicted motion vectors, and/or any data related to multi-object tracking). For example, the trainer 120 can predict the same object moving across multiple frames by analyzing its trajectory and object characteristics. In some implementations, the active trainer 124 (described in more detail below) can output the output request(s) 128 for annotation (e.g., highlighting uncertain object associations, flagging ambiguous object detections, and/or any uncertain label predictions for manual review).

In some implementations, the pretrainer 112, trainer 120, and/or active trainer 124 can maintain, execute, train, and/or update one or more machine-learning models during the encoding stage. In some implementations, the machine-learning model(s) can include any type of graph-based machine-learning models capable of associating object detections across multiple frames (e.g., graph neural networks (GNNs)) to refine object tracking associations over time). For example, the machine-learning model(s) can be trained and/or updated to use node and edge embeddings to track object movement across frames, among other predictive tasks. The machine-learning model(s) can be or include a hierarchical-based model (e.g., multi-layered GNNs, deep learning-based object tracking models, temporal association models). The machine-learning model(s) can be or include a GNN-based multi-object tracking model, in some implementations. The pretrainer 112, trainer 120, and/or active trainer 124 can execute the machine-learning model to generate outputs. The pretrainer 112, trainer 120, and/or active trainer 124 can receive data to provide as input to the machine-learning model(s), which can include synthetic data, synthetic labels, real data, pseudo-labels, video data from various camera feeds, and/or any sensor-derived tracking data.

The pretrainer 112, trainer 120, and/or active trainer 124 can include at least one neural network (e.g., model 116). The model 116 can include a first layer, a second layer, and/or one or more subsequent layers, which can each have respective nodes. That is, the model 116 can include a node-based architecture for representing object detections as shown in a graph structure. For example, the first layer can process initial object detections based on pixel data and outputs from detection candidates, where at least one (e.g., each) detection can be represented as a node. For example, the second layer can form associations between objects detected in sequential frames by analyzing the edges between nodes, representing potential object movement across frames. For example, the subsequent layers 336 can progressively refine these associations to form trajectory-level labels by modeling spatio-temporal dependencies between objects and removing invalid associations. That is, the output from the GNN hierarchy of the model 116 can be refined trajectory-level labels indicating the continuous movement paths of objects across the video sequence, based on both node (e.g., object) and edge (e.g., association) predictions. For example, a first level of the hierarchical structure of the model 116 can generate at least one label for at least one detection candidate of the plurality of detection candidates. Additionally, one or more subsequent levels of the hierarchical structure of the model 116 can generate at least one label for one or more predicted associations between the plurality of detection candidates.

In some implementations, the system 100 can configure (e.g., train, update, fine tune, apply transfer learning to) the model 116 by modifying or updating one or more parameters, such as weights and/or biases, of various nodes of the model 116 responsive to evaluating estimated outputs of the model 116 (e.g., generated in response to receiving synthetic data, synthetic labels, pseudo-labels, and/or real data). The pretrainer 112, trainer 120, and/or active trainer 124 can be or include various neural network models, including models that can operate on or generate data for multi-object tracking, including but not limited to pseudo-labels, trajectory data, bounding box coordinates, or various combinations thereof.

In some implementations, the pretrainer 112, trainer 120, and/or active trainer 124 can be configured (e.g., trained, updated, fine-tuned, has transfer learning performed, etc.) based at least on the synthetic data, synthetic labels, pseudo-labels, and/or real data. For example, one or more example tracking sequences and/or sensor data of moving objects can be applied (e.g., by the system 100, or in stage performed by the system 100 or another system) as input to the pretrainer 112, trainer 120, and/or active trainer 124 to cause the pretrainer 112, trainer 120, and/or active trainer 124 to generate an estimated output. The estimated output can be evaluated and/or compared with ground truth data (or manually annotated data) of the tracking sequences that correspond with the object labels (e.g., object position, velocity, direction) and/or tracking sequences of moving objects (e.g., vehicles, pedestrians, animals), and the model 116 of the pretrainer 112, trainer 120, and/or active trainer 124 can be updated based at least on the discrepancies and/or performance metrics. For example, based at least on an output of tracking sequences, one or more parameters (e.g., weights and/or biases) of the model 116 of the pretrainer 112, trainer 120, and/or active trainer 124 can be updated.

In some implementations, the pretraining stage can be the stage in the labeling pipeline in which the system 100 can initialize the model 116 using synthetic data (e.g., the content data 104 and content labels 108). That is, the content data 104 can be synthetic representations of various object interactions and environments (e.g., simulated frames, artificial sensor data, virtual object trajectories, synthetic 3D models, and simulated environmental conditions), and the content labels 108 can be predefined annotations for object tracking in the synthetic environments (e.g., bounding boxes, object movement paths, object classifications, simulated object interactions, and temporal tracking labels across frames). The system 100 can include at least one pretrainer 112. The pretrainer 112 can update a graph neural network (GNN) (e.g., the model 116) based at least on video data (e.g., the content data 104) representing a plurality of first objects and a plurality of first labels corresponding to the plurality of first objects. That is, the pretrainer 112 can generate initial associations and object predictions without the need for real-world data. For example, during the pretraining stage the pretrainer 112 can simulate various tracking scenarios to cause the model 116 to learn object behaviors and movements under controlled synthetic environments.

In some implementations, videos can include specific characteristics that can be used to enhance multi-object tracking (MOT) performance. Frame-wise similarities in videos can generate data redundancies, which can be used by the pretrainer 112 within the system 100. For example, the redundancy can allow the pretrainer 112 to reduce the occurrence of and/or need for manual annotations by identifying associations between objects detected in different frames. The pretrainer 112 can pre-train the model 116 on synthetic data (e.g., containing the content data 104 and content labels 108), which can include generating pseudo-labels for object detections and corresponding trajectories of a plurality of sequential and/or non-sequential video frames. Additionally, object dependencies can impact the object tracking pipelines, as the annotations of one frame can impact subsequent frames. For example, associations resolved for an object in a given frame can propagate across neighboring tracks, reducing the complexity of labeling subsequent frames. That is, the pretrainer 112 can be used to perform track-based labeling.

In some implementations, the pretrainer 112 of the system 100 can initialize the model 116 using synthetic datasets (e.g., simulations of real-world environments). That is, the synthetic datasets can include content data 104 including object trajectories (e.g., moving vehicles in traffic simulations or robots in industrial settings) and the content labels 108 labeling the content data 104 across multiple frames. For example, synthetic data can contain pre-labeled bounding boxes for vehicles, pedestrians, or moving machinery within industrial facilities. The pretrainer 112 can use the synthetic data to determine initial associations between nodes (e.g., object detections in individual frames) and edges (e.g., object movements across frames). The initialization can allow the model 116 to recognize object trajectories and predict associations (e.g., before being trained using real-world data). In some implementations, during the pre-training stage, the pretrainer 112 can also generate pseudo-labels for the model 116 to refine its object tracking functionality. For example, the pretrainer 112 can generate synthetic video data where objects follow pre-defined paths, and the model 116 can be trained to infer object associations based on these paths.

In some implementations, the training stage can be the stage in the labeling pipeline in which the system 100 can refine the model 116 using real-world data. The system 100 can include at least one trainer 120. The trainer 120 can cause the graph neural network (e.g., the model 116) to generate a plurality of second labels of a first example video and update the graph neural network based at least on the plurality of second labels and the first example video. That is, the trainer 120 can apply real-world data to further improve the predictions of the model 116 by retraining it based on pseudo-labeled outputs. For example, during the training stage the trainer 120 can refine object tracking by adjusting associations between detected objects across frames in real-world datasets (e.g., video recordings, real-time video feeds).

In some implementations, the trainer 120 of the system 100 can update the model 116 during the training stage. That is, real world data can be used to update the model 116. For example, real world data can include, but is not limited to, urban traffic video sequences, crowd monitoring footage, wildlife tracking videos, warehouse robot monitoring footage, manufacturing assembly line video, hospital surveillance, video recordings from surveillance systems, sensor data from autonomous vehicles, and/or drone footage from industrial sites. The trainer 120 can input the real-world datasets into the model 116, and the model 116 can output (or generate) pseudo-labels for detected objects and their associated movements. For example, the model 116 can predict whether an object detected in a warehouse surveillance video corresponds to the same object detected in previous frames (e.g., establishing object continuity across frames). In this example, the model 116 can track moving objects such as forklifts, conveyor belts, or inventory carts across multiple video frames. The trainer 120 can refine the predictions of the model 116 during this training stage, facilitating the adjustment in predictions for object tracking and association based on the pseudo-labeled data.

In some implementations, the active learning stage can be the stage in the labeling pipeline in which the system 100 can refine the model 116 by identifying uncertain predictions. The system 100 can include at least one active trainer 124. The active trainer 124 can cause the graph neural network (e.g., the model 116) to generate a plurality of third labels of a second example video. Additionally, the active trainer 124 can cause the graph neural network (e.g., the model 116) to generate at least one third label of the plurality of third labels corresponding to an uncertainty score. That is, active learning and/or training can selectively prioritize data samples (e.g., video frames, detected objects, object associations, bounding boxed, and/or trajectory segments) based on model uncertainty to improve the training process by focusing annotation efforts on areas where the model 116 has lower prediction confidence (e.g., uncertain associations, ambiguous detections, complex object interactions, frames with occlusions, and/or instances with overlapping objects). Additionally, the active trainer 124 can output a request for a modification to the at least one third label responsive to the uncertainty score satisfying an annotation criterion. That is, the active trainer 124 can identify and prioritize uncertain object associations or detections for manual review or correction by an annotator. For example, during the active learning stage the active trainer 124 can flag object associations with high uncertainty (e.g., due to occlusions or fast movements) and prompt the system 100 or annotator to validate or modify those associations.

In some implementations, the active trainer 124 of the system 100 can further update the model 116 by further modeling the most uncertain pseudo-labels (e.g., identifying uncertain associations between object detections across frames where the confidence score of the model is low, such as in cases of occlusions, rapid object movement, or poor lighting conditions). The active trainer 124 can calculate uncertainty values for at least one (e.g., each) object association predicted by the model 116. The uncertainty values can be derived from probabilistic metrics (e.g., entropy, confidence scores from object association predictions). That is, the uncertainty value can be a probabilistic metric that quantifies the confidence of the model 116 in prediction outcomes (e.g., guiding further annotation or refinement for predictions with lower confidence). For example, objects detected in video sequences where occlusions or fast movements are present can have low-confidence associations, and the active trainer 124 can flag (label) these objects for review in the output request 128. That is, the active trainer 124 can forward the uncertain labels in the output request 128 to an annotator or annotation system for validation. For example, the annotator can review the flagged labels, confirm object associations, correct errors in object detection, or adjust bounding boxes around the detected objects. Additionally, the annotator can review the flagged pseudo-labels and confirm the correct object associations, allowing the model 116 to refine its tracking performance based on this manual feedback. In some implementations, the active trainer 124 of the system 100 can utilize this feedback loop to further refine the model 116 to improve output performance in tracking objects across video sequences. That is, by focusing on the most uncertain pseudo-labels and obtaining manual annotations only for these cases, the active trainer 124 can improve the efficiency of the annotation process.

In some implementations, the system 100 can achieve near-ground-truth labeling performance with minimal or reduced manual intervention by using a combination of synthetic pre-training, pseudo-labeling, and active learning. That is, the system 100 can generate labels that approach the accuracy of ground truth labels, requiring only 3-20% of manual annotation effort across various datasets and/or a lower percentage based on the dataset complexity and tracking implementation. The system 100 can provide labeling performance across different domains, such as autonomous vehicles, surveillance systems, and industrial robotics, using the pretrainer 112, trainer 120, and active trainer 124 to improve the tracking accuracy of the model 116. As the model 116 is trained and implemented to minimize and/or reduce human intervention, the model 116 can achieve improved video annotation.

In some implementations, the model 116 can be a hierarchical graph neural network (GNN) model. That is, the model 116 can be used to capture long-term spatio-temporal dependencies between tracked objects. The pretrainer 112 can initialize the GNN by training the model 116 on synthetic data, generating object detection and association predictions across multiple frames. The hierarchical GNN formulation can allow the model 116 to process long-range dependencies (e.g., outputs and/or estimations made in one frame can propagate across multiple frames). In some implementations, the model 116 can be used to classify nodes (e.g., object detections) into valid or invalid object estimates and/or hypotheses, allowing the model 116 (e.g., GNN) to filter out false positives before making final tracking predictions. For example, the pretrainer 112 can train the GNN to identify false positives introduced by noisy sensor data or occlusions in video sequences. In some implementations, the trainer 120 can further fine-tune the model 116 by retraining the model 116 on pseudo-labels generated from real-world data. As the model 116 is retrained on its own pseudo-labels, the model 116 can improve in accuracy and/or other performance metrics for object detection and association predictions across diverse datasets.

To process more complex or uncertain decisions, the active trainer 124 can focus on and/or prioritize reviewing object associations with high uncertainty scores. For example, the active trainer 124 can determine uncertainty scores for each node (object detection) and edge (object association) in the GNN. In this example, the uncertainty scores can quantify the confidence of the predictions of the model 116 and can be used to flag nodes or edges that require manual annotation. In some implementations, when the active trainer 124 facilitates annotations at higher levels of the model 116, the hierarchy can propagate down to lower levels. Thus, hierarchical annotations performed by the active trainer 124 can allow the system 100 to determine multiple uncertainties with a single (or relatively few) manual annotation(s).

In some implementations, the system 100 (e.g., implemented using the pretrainer 112, trainer 120, and active trainer 124) can use a graph-based model for object tracking. That is, given a set of object candidates O, the system 100 can identify a subset of objects Oᵥ⊂O and corresponding trajectories T. At least one (e.g., each) trajectory Tk ET can include objects that share the same identity, and the system 100 can model the associations between these objects using edges in an undirected graph G=(V, E), where V represents the nodes (e.g., object detections) and E represent the edges (e.g., associations between objects across frames). For example, in a multi-object tracking example involving pedestrians and vehicles in a city environment, the model 116 can be used to classify at least one (e.g., each) detected object u E V as a valid object if, for example, it belongs to the set of valid objects Oy and/or is associated with valid trajectories based on spatio-temporal consistency across frames

The system 100 can also refine the object tracking process by using the model 116 (e.g., hierarchical GNN model) to progressively merge object candidates from one level into longer trajectories at subsequent levels. The model 116, trained by the pretrainer 112 and the trainer 120, can propagate information across the graph via message passing, updating the node and edge embeddings with richer information. Specifically, nodes (e.g., object candidates) can be represented by embeddings that capture spatio-temporal features, such as bounding box coordinates, object dimensions, and timestamps. The system 100 can classify edges (e.g., association hypotheses) into active and inactive associations based on predictions of the model 116.

The active trainer 124 can determine the uncertainty for at least one (e.g., each) edge prediction using probabilistic metrics (e.g., entropy or at least one probabilistic metric). For example, the uncertainty for an edge can be determined by (Equation 1):

$$uncert ( v ) = {max}_{u ∈ {N}_{v}} H ( {\hat{y}}_{( v , u )} )$$

where uncert(v) can be the uncertainty associated with node v, and Nᵥ can be the set of neighboring nodes to v. The entropy function H(ŷ_{(v,u)}) can be determined by (Equation 2):

$$H ( {\hat{y}}_{( v , u )} ) : = - ( {\hat{y}}_{( v , u )} log {\hat{y}}_{( v , u )} + ( 1 - {\hat{y}}_{( v , u )} ) log ( 1 - {\hat{y}}_{( v , u )} )$$

representing the uncertainty of the association between node v and its neighboring node u, where ŷ_{(v,u)} can be the predicted probability of the model 116 that nodes v and u belong to the same object trajectory

In some implementations, the active trainer 124 can determine the maximum uncertainty for a node v by determining the entropy for all or some edges connecting v to its neighboring nodes u E Ny, and then select the edge and/or edges with the highest uncertainty for further manual annotation or correction. Additionally, the model 116 can perform node classification by determining whether a node u E V represents a valid object hypothesis. That is, the active trainer 124 can use the node embeddings generated by the model 116 to classify nodes into valid or invalid object hypotheses (e.g., to filter out false positives). In some implementations, the object tracking pipelines can be further optimized by distributing the annotation budget across multiple levels of the hierarchy. The active trainer 124 can allocate the annotation budget B across the hierarchical levels L, such that the sum of the budgets B₁+ . . . +B_{L}=B. In deeper levels of the hierarchy, nodes can represent longer object trajectories (e.g., tracklets), such that the system 100 can propagate annotation decisions across multiple frames.

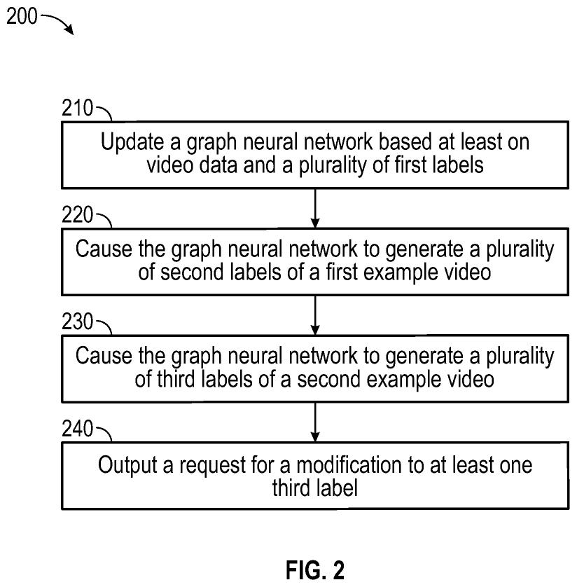

With reference to FIG. 2, an example flow diagram illustrating a method for multi-object tracking in an object tracking pipeline, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 4A-4C), one or more computing devices or components thereof (e.g., as described in FIG. 5), and/or one or more data centers or components thereof (e.g., as described in FIG. 6).

Now referring to FIG. 2, each block of method 200, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a self-contained microservice via an application programming interface (API) or a plug-in to another product, to name a few. In addition, method 200 is described, by way of example, with respect to the system of FIG. 1. However, this method can additionally or alternatively be executed by any one system, or any combination of systems, including, but not limited to, those described herein.

FIG. 2 is a flow diagram showing a method 200 for updating, causing, and outputting operations, in accordance with some implementations of the present disclosure. Various operations of method 200 can relate to improving the performance of multi-object tracking systems. Existing systems rely on manually labeled datasets where each object and its trajectory are annotated across frames in video sequences. This approach is resource-intensive as labeling large datasets includes processing large amounts of redundant data across sequential frames, where objects often remain unchanged. As a result, the overall data processing throughput is reduced, and the system exhibit inefficiencies in time and computational resources required to generate the annotations. Method 200 of FIG. 2 can solve these technological problems by implementing a graph neural network (GNN) model with hierarchical structure, synthetic pretraining, pseudo-label generation, and active learning, thereby improving multi-object tracking accuracy and reducing the dependence on manual labeling.

The method 200, at block 210, includes updating (e.g., synthetic pretraining) a GNN (e.g., detection model) based at least on video data (e.g., synthetic data) to represent a plurality of first objects and a plurality of first labels (e.g., synthetic labels) corresponding to the plurality of first objects. In some implementations, the processing circuits can initialize the GNN using synthetic data generated from a simulation environment. That is, the processing circuits can use synthetic labels (e.g., pre-labeled bounding boxes, trajectories generated by simulation tools) to simulate object trajectories (e.g., the motion paths of vehicles in a traffic simulation, animals in a wildlife tracking environment, or robots in a manufacturing facility). For example, the processing circuits can use synthetic pretraining to initialize the GNN by providing labeled trajectory data (e.g., pre-defined object paths across frames in synthetic video sequences), facilitating the GNN to infer object positions and associations before being trained on real data (e.g., video recordings, captured sensor data, LiDAR point cloud data, radar signal data). Additionally, the processing circuits can implement unsupervised learning techniques, refining detection accuracy based on simulation-generated metrics (e.g., object velocities, object accelerations).

In some implementations, the GNN can include a hierarchical structure such that the processing circuits can cause the GNN to generate a plurality of detection candidates. That is, the GNN can include a first level (or layer), one or more additional levels (e.g., second level (or layer), third level (or layer), output level (or layer) etc.). That is, the graph neural network can treat objects as nodes and their associations (e.g., connections between detections in different frames) as edges in the graph. For example, the first level or layer can generate node-level predictions (e.g., identifying object locations in individual frames). For example, an additional level or layer can generate edge-level predictions (e.g., associating detected objects across different frames, indicating the same object is tracked over time).

In some implementations, the processing circuits can train and/or implement the GNN to perform one or more predictions on nodes in a first level. For example, the processing circuits can predict the presence of detected objects (e.g., cars, pedestrians, drones, industrial machinery, livestock, robotic arms, humans in a sports activity, wildlife, etc.) in one or more video frames based on pixel data or feature extraction. Additionally, the processing circuits can train and/or implement the graph neural network to perform one or more predictions on edges in a second level and/or subsequent levels. For example, the processing circuits can predict whether objects detected in different frames are associated with each other (e.g., determining that objects in two sequential frames represent the same entity). In some implementations, the processing circuits can generate at least one label for at least one detection candidate (e.g., object position in frame, object category, object velocity) of the plurality of detection candidates at a first hierarchical level. That is, the processing circuits can use object-level predictions (e.g., bounding boxes around detected objects in individual frames) to generate initial tracking labels.

In some implementations, the processing circuits can generate, at a first hierarchical level of the graph neural network, at least one label for one or more predicted associations (e.g., temporal continuity between detected objects, trajectory intersections, object occlusions) between the plurality of detection candidates (e.g., objects detected in separate video frames). For example, the processing circuits can determine whether two detected objects in different frames correspond to the same real-world entity (e.g., whether a vehicle detected in frame 1 is the same vehicle in frame 3). In some implementations, the processing circuits can generate, at one or more subsequent hierarchical levels of the graph neural network, at least one label for one or more predicted associations between the plurality of detection candidates. That is, the processing circuits can use the subsequent hierarchical levels of the graph neural network to refine object association predictions by updating the labels on edges (e.g., connections between nodes representing detections across frames). The edges can represent predicted associations between objects in different frames, and processing circuits in subsequent levels in the hierarchy can refine these associations by analyzing relationships between nodes (e.g., detections of objects) across frames.

In some implementations, the video data can include a plurality of synthetic data samples corresponding to a plurality of simulated trajectories (e.g., predefined paths representing objects moving through simulated environments) of the plurality of first objects in a plurality of environments (e.g., urban traffic simulation, pedestrian interaction scenarios). The processing circuits can use synthetic data (e.g., labeled simulated video sequences, predefined object paths, synthetic occlusion events) for the initial training phase of the graph neural network. That is, the synthetic data can contain simulated trajectories for multi-object tracking scenarios (e.g., predicting when objects will occlude each other, predicting object reappearances after occlusion). In one or more embodiments, simulated occlusion events allow the GNN to predict the reappearance points of objects after occlusion. For example, simulated data can include varied environmental conditions (e.g., low-light conditions, object interactions at different speeds). In this example, the processing circuits can update the GNN to learn features invariant to lighting or motion.

In some implementations, updating the GNN can include using the plurality of synthetic data samples to pre-train the GNN to generate the plurality of second labels (e.g., pseudo-labels generated from initial predictions) of the first example video. That is, the processing circuits can perform pre-training by inputting the synthetic data into the GNN and allowing the network to learn associations between object detections (e.g., determining if two objects in different frames are the same based on their movement). For example, the processing circuits can train the GNN to learn object interaction rules (e.g., pedestrian crossing intersections) based on simulated multi-object tracking scenarios.

In some implementations, the video data can include data captured from (or using) a plurality of cameras positioned in an environment (e.g., multi-camera traffic systems, surveillance camera networks, autonomous vehicle camera arrays, etc.). That is, in a multi-camera environment the processing circuits can fuse and/or blend multi-view data to track objects across different camera perspectives. Additionally, the processing circuits can integrate data (e.g., video feeds, depth maps, stereo vision) from the plurality of cameras to perform multi-object tracking into the GNN. That is, the processing circuits can perform the integration by mapping object detections from 2D image planes into a shared 3D coordinate system. For example, the processing circuits can reconstruct 3D object trajectories by correlating object positions from one or more perspectives of the cameras. In some implementations, the processing circuits can cause the graph neural network to perform a two-dimensional (2D) to three-dimensional (3D) (e.g., 2D-3D tracking) transformation on a second example video. That is, the processing circuits can determine depth and distance information from the video data to improve tracking performance in 3D space.

In some implementations, the processing circuits using the GNN can process 2D tracking data (e.g., pixel coordinates, object bounding boxes) to generate 3D spatial trajectories (e.g., real-world object coordinates over time). That is, the processing circuits can use depth information (e.g., vision data) and/or geometric constraints (e.g., epipolar geometry) derived from the video data to construct trajectories of the objects across frames. For example, the processing circuits can estimate object movement vectors based on changes in depth and position over time. For example, the processing circuits can resolve ambiguities in object association by using multi-camera depth data to determine object proximity and overlaps in 3D space.

The method 200, at block 220, includes causing (e.g., training with pseudo-labels) the graph neural network to generate a plurality of second labels of a first example video (e.g., non-synthetic data, unlabeled video sequences, or partially labeled datasets) and update (e.g., retrain the graph neural network based at least on the pseudo-label output) the graph neural network based at least on the plurality of second labels and the first example video. In some implementations, pseudo-labels (e.g., a set of predictions generated by the GNN) can represent the predicted association between objects (detections) across frames. For example, at least one (e.g., each) edge in the graph structure can correspond to a decision about whether two detections in different frames are linked (e.g., represent the same object) based on their motion paths and proximity.

In some implementations, the processing circuits can use confidence metrics (e.g., probability scores, association thresholds) to determine the validity of pseudo-labels. That is, the processing circuits can iteratively refine the pseudo-labels as the GNN generates new predictions during the retraining phase. For example, the processing circuits can update the graph neural network by selectively retraining the GNN on video segments where prediction confidence is low (e.g., associations with low probability scores between detections). Additionally, the processing circuits can dynamically adjust the pseudo-label thresholds based on real-time model feedback (e.g., adjusting the confidence threshold when new training data is introduced).

In some implementations, the plurality of second labels can correspond to one or more predicted associations between a plurality of second objects in a plurality of frames of the first example video. That is, the predicted associations can be relationships and/or connections between objects (or their detections) over time (e.g., inferred from object motion patterns). The processing circuits can cause the GNN to determine the associations by analyzing sequential data (e.g., detecting changes in object location across frames) and/or calculating the likelihood that two detections in adjacent frames correspond to the same object based on spatial continuity and/or temporal continuity.

The method 200, at block 230, includes causing (e.g., by causing active learning) the GNN to generate a plurality of third labels of a second example video. That is, at least one third label of the plurality of third labels correspond to an uncertainty score (e.g., entropy representing how confident the neural network is about the label). The uncertainty score of the plurality of third labels can be based at least on entropy or at least one probabilistic metric derived from an output of the GNN. The processing circuits can quantify uncertainty in tracking predictions using entropy and/or a probabilistic metric.

The method 200, at block 230, includes causing (e.g., active learning) the graph neural network to generate a plurality of third labels of a second example video. That is, at least one third label of the plurality of third labels corresponds to an uncertainty score (e.g., entropy representing how confident the neural network is about the label). The uncertainty score of the plurality of third labels can be based at least on entropy or at least one probabilistic metric derived from an output of the graph neural network. The processing circuits can quantify uncertainty in tracking predictions using entropy (e.g., calculating disorder in the association probabilities) and/or a probabilistic metric (e.g., Bayesian inference, variance-based metrics).

In some implementations, the entropy can correspond to a measure of uncertainty in the one or more predicted associations of the plurality of third objects across the plurality of frames. For example, the processing circuits can calculate entropy by analyzing the distribution of association probabilities for an object across frames (e.g., wide probability distributions indicate higher uncertainty). The processing circuits can determine the uncertainty by determining prediction consistency across frames (e.g., checking whether predicted associations for an object maintain a similar probability range over time). Additionally, the processing circuits can generate and/or determine other probabilistic metrics such as, but not limited to, variance, confidence intervals, likelihood estimates, posterior distributions, maximum likelihood estimation (MLE), and/or Bayes factors. For example, the processing circuits can generate posterior probabilities for object associations to quantify confidence in predictions. In this example, the posterior probability can be used as the uncertainty score representing the likelihood that a detected object in frame 1 matches a detected object in frame 2. For example, the processing circuits can generate variance-based metrics to analyze the variability in predicted associations across frames. In this example, the variance score can be used as the uncertainty score representing prediction stability over time.

For example, the uncertainty score can quantify the correctness of the association between object detections across frames. In some implementations, the plurality of third labels can correspond to one or more predicted associations (e.g., relationships or connections between objects) between a plurality of third objects across a plurality of frames of the second example video. That is, the processing circuits can perform labeling at a track level (e.g., associating object tracks over time, consolidating object trajectories) by generating the third labels on the edges (e.g., connections between object detections across frames, temporal associations) to determine the continuity of one or more tracks across the plurality of frames of the example video. For example, the processing circuit can perform labeling by iterating over detected object trajectories and verifying temporal consistency (e.g., whether an object detected in frame 1 follows a plausible trajectory into frame 2 based on motion vectors). For example, the processing circuits can generate the third labels by refining predicted associations using high-confidence regions of the video (e.g., segments where object motion and appearance are stable).

In some implementations, the processing circuits can cause the GNN to generate a graph representation of the second example video, including a plurality of nodes and a plurality of edges. That is, the nodes (e.g., object detections in individual frames, object bounding boxes) can represent a plurality of detections of the plurality of third objects (e.g., vehicles, pedestrians) across the plurality of frames. Additionally, the edges (e.g., temporal links between nodes, predicted associations between objects in different frames) can represent the one or more predicted associations. For example, processing circuits can generate the second example video by constructing a graph where nodes are connected based on spatial and temporal proximity (e.g., nodes representing objects detected in adjacent frames are linked by edges if their locations and velocities suggest they are the same object). In this example, the nodes can be object detection instances (e.g., bounding boxes around objects in each frame), and the edges can be predicted associations (e.g., probability-based links connecting the same object across multiple frames). It should be understood that while nodes and edges are described with reference to the second example video, other implementations and configurations can be used to represent the second example video such as, but not limited to, directed graphs, weighted graphs, bipartite graphs, and/or any other graph structures optimized for object tracking.

In some implementations, at least one (e.g., each) edge can represent a predicted association between the detections of the connected nodes (e.g., indicating that the neural networks predict the nodes belong to the same object across frames). For example, a predicted association can be determined by comparing object attributes (e.g., bounding box size, motion direction, velocity) and determining whether the objects in different frames are likely the same entity based on these attributes. For example, a predicted association can be determined by analyzing appearance-based features (e.g., color histograms, texture patterns) to link objects across frames. In some implementations, at least one edge of the plurality of edges can be associated (e.g., linked, weighted, parameterized) with a corresponding label of the plurality of third labels. That is, edges can be elements (e.g., connections between object detections) and/or links (e.g., temporal connections across frames) containing labels indicating the predicted continuity of an object across multiple frames.

The method 200, at block 240, includes outputting a request for a modification to the at least one third label responsive to the uncertainty score satisfying an annotation criterion. The third label can be an object detection association generated by the GNN with a low-confidence score (e.g., entropy exceeding a pre-defined threshold). In some implementations, the processing circuits can send the most uncertain labels to an annotator or another system for further processing and/or labeling. The annotation criterion can correspond to a threshold (e.g., an uncertainty threshold) for selecting a subset of the plurality of third labels having corresponding uncertainty scores satisfying the threshold. That is, the annotation criterion can be, but is not limited to, entropy thresholds, confidence intervals, prediction variance, association likelihoods, maximum uncertainty, prediction consistency, and/or any other statistical measure of uncertainty. For example, the processing circuits can generate a request when the entropy score exceeds a defined threshold, indicating that manual labeling is needed to resolve ambiguous object associations. Additionally, the request can include details about the specific associations requiring confirmation (e.g., associations between particular frames, regions of interest in the video). For example, the processing circuits can output the request for annotation based on edge-specific uncertainty (e.g., low-confidence links between detections in different frames) by marking edges for manual review.

In some implementations, the request for modification can include a plurality of selectable actions (e.g., confirmation of association validity, modification of bounding boxes, removal of erroneous detections, and/or any interface object to facilitate actions for an annotator to perform) for modifying the at least one third label. For example, at least one selectable action can include the processing circuits receiving a confirmation command, confirming (e.g., an action to confirm) a validity (e.g., accepting the predicted association as correct) of at least one of the one or more predicted associations between at least two detections of the plurality of detections. In this example, the confirmed association can be updated in the GNN as a valid object track, contributing to future predictions. For example, at least one selectable action can include the processing circuits receiving a removal command, removing (e.g., an action to remove) at least one detection of the plurality of detections. In this example, the GNN discards the removed detection, ensuring it is not considered in future frames. For example, at least one selectable action can include the processing circuits receiving a modification command, modifying (e.g., an action to modify) spatial boundaries of a bounding box (e.g., refining the bounding box dimensions) of the at least one detection. In this example, the processing circuits can adjust the detection box dimensions to improve the accuracy of object localization. For example, at least one selectable action can include the processing circuits receiving an association command, associating (e.g., an action to associate) the at least one detection (e.g., associating bounding boxes of detected objects) in a first frame of the plurality of frames to another detection in a second frame of the plurality of frames. In this example, the GNN updates the object trajectory by linking the detections across multiple frames based on the new association.

Disclosed implementations can be included in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

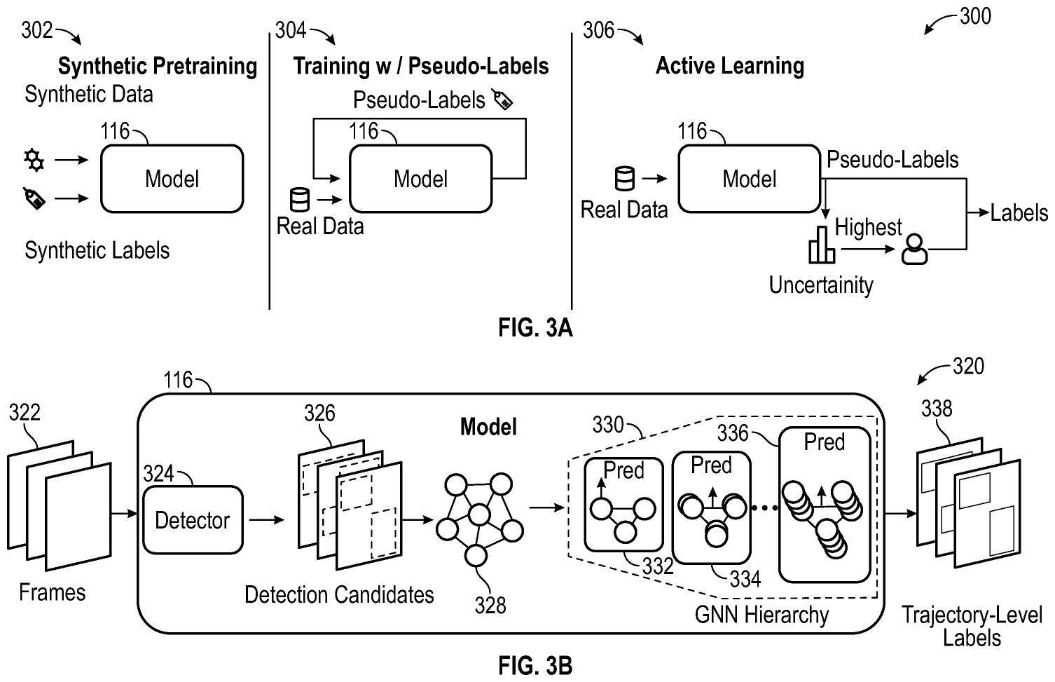

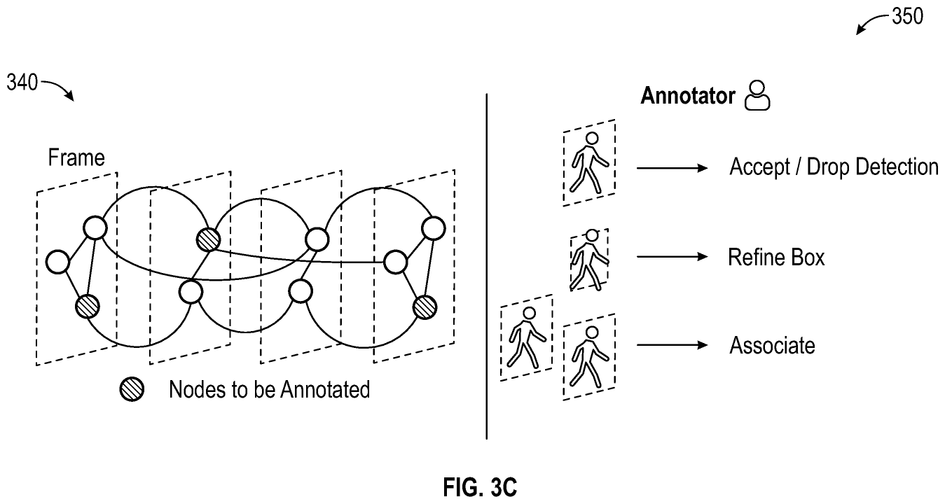

Referring now to FIG. 3A, an example multi-stage training process 300 including any one or more synthetic pretraining, training with pseudo-labels, and active learning, in accordance with some implementations of the present disclosure. At the synthetic pretraining stage 302, the processing circuits of the system 100 can initiate synthetic pretraining using the model 116. The synthetic data (e.g., simulated video frames, artificial sensor data) and synthetic labels (e.g., predefined bounding boxes, simulated object trajectories) can be inputted to the model 116 (e.g., GNN). The synthetic data and labels can allow the processing circuits to initialize the model 116 by training it to recognize object movements across multiple frames. For example, synthetic labels can include pre-labeled bounding boxes indicating object positions at various time intervals, causing the model 116 to learn object detection and tracking before being trained using real-world data. That is, the processing circuits performing the synthetic pretraining stage 302 can cause the model 116 to generate initial node associations (e.g., object detections identified in discrete frames) and edge predictions (e.g., inferred object transitions across sequential frames) based on synthetic data, without incorporating real-world data inputs.

At training with the pseudo-labels stage 304, the processing circuits of the system 100 update the model 116 by training it with pseudo-labels (e.g., predicted bounding boxes, object categories, tracking identifiers, movement paths, and/or any association data) derived from real data (e.g., video recordings from surveillance cameras, sensor data from autonomous vehicles). The processing circuits can cause the model 116 to use the pseudo-labels to infer object positions and associations across sequential and/or non-sequential frames of real data. For example, pseudo-labels can represent whether objects detected in one frame are the same objects detected in subsequent frames and/or non-sequential frames. In some implementations, the processing circuits can apply the pseudo-labels to track objects across multiple frames. The processing circuits can update the model 116 (e.g., continuously, automatically, and/or periodically) by refining the associations between nodes (e.g., object detections in the frames) and edges (e.g., predicted object movement between frames), allowing the model 116 to improve its multi-object tracking accuracy.

At the active learning stage 306, the processing circuits of the system 100 performs active learning. In some implementations, the processing circuits can calculate uncertainty scores for at least one (e.g., each) pseudo-label based on probabilistic metrics (e.g., entropy, confidence scores from model predictions). Pseudo-labels with higher uncertainty scores can be prioritized for further annotation. For example, the processing circuits can flag pseudo-labels associated with objects in frames where the model 116 exhibits low confidence (e.g., due to occlusion, rapid movement) for further validation. The processing circuits can send the pseudo-labels to an annotator or an annotation system for correction or confirmation. In some implementations, the annotator can confirm the associations, remove incorrect detections, and/or adjust bounding boxes around objects in the frames.

Referring now to FIG. 3B, an example system configuration 320 illustrating detection and tracking within a graph neural network (GNN) hierarchy pipeline, in accordance with some implementations of the present disclosure. The processing circuits of the system 100 can execute the model 116 to process the sequential and/or non-sequential input frames 322, representing a video stream or series of captured images. The processing circuits can perform object detection using the detector 324. That is, the detector 324 can process at least one (e.g., each) frame individually (or in groups) to identify objects based on spatial data (e.g., bounding box coordinates and spatial characteristics). The detector 324 can be configured to use a neural network that analyzes pixel data to locate potential objects, outputting the detection candidates 326 for each frame.

In some implementations, the detection candidates 326 can represent identified objects within at least one (e.g., each) frame, including information such as bounding box locations and other spatial properties. The processing circuits can generate a graph structure 325 where the input detection candidates 326 can be structured. That is, in the graph structure 328, each node can represent an object detected in an individual frame and edges can represent associations between objects across sequential frames, allowing the processing circuits to establish object continuity over time. For example, edges can indicate that objects detected in different frames correspond to the same physical entity, creating an association based on parameters such as position, velocity, and appearance similarity.

In some implementations, the processing circuits can apply a GNN hierarchy 330 to the graph 328, including multiple levels (332, 334, 336) to iteratively refine object associations. At least one (e.g., each) level within the GNN hierarchy 330 can process nodes and edges in the graph, generating predictions (indicated as “Pred”) that refine object tracking across frames. For example, the level 332 can be used to generate initial associations between nodes based on spatial proximity and appearance features and the level 334 can be used to refine these associations by factoring in additional temporal data such as direction of movement. In the subsequent level 336, the processing circuits can output trajectory-level associations by consolidating the refined paths, thereby tracking objects across multiple frames with increased reliability.

FIG. 3C is an example illustration of an annotation process, in accordance with some implementations of the present disclosure. The processing circuits analyze frames where nodes represent detected objects across sequential frames, with specific nodes highlighted for annotation. The highlighted nodes can indicate areas with elevated uncertainty or challenging associations requiring manual intervention. The annotator 350 can interact with the highlighted nodes, performing actions such as accepting or discarding detections, refining bounding boxes for improved localization, and/or associating nodes across frames to confirm object continuity. For example, the processing circuits can prompt the annotator to refine a bounding box to align accurately with a position of an object within a frame or to identify associations between nodes across frames to validate consistent tracking.

### Example Language Models

In at least some implementations, language models, such as large language models (LLMs), vision language models (VLMs), multi-modal language models (MMLMs), and/or other types of generative artificial intelligence (AI) can be implemented. Generally, the language models can support multi-object tracking by employing hierarchical graph neural networks (GNNs) that leverage synthetic pre-training, pseudo-labeling, and active learning to improve labeling efficiency and accuracy across video frames. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models can be considered “large,” in implementations, based on the models being trained on massive datasets and having architectures with large number of learnable network parameters (weights and biases)—such as millions or billions of parameters. The LLMs/VLMs/MMLMs/etc. can be implemented for summarizing textual data, analyzing and extracting insights from data (e.g., textual, image, video, etc.), and generating new text/image/video/etc. styles, tones, and/or formats. The in user-specified LLMs/VLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures can be implemented in various implementations. For example, different architectures can be implemented that use different techniques for understanding and generating outputs—such as text, audio, video, image, 2D and/or 3D design or asset data, etc. In some implementations, LLMs/VLMs/MMLMs/etc. architectures such as recurrent neural networks (RNNs) or long short-term memory networks (LSTMs) can be used, while in other implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/VLMs/MMLMs/etc. can also include one or more diffusion block(s) (e.g., denoisers). The LLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/VLMs/MMLMs/etc. that include both encoder and decoder components like T5 (Text-to-Text Transformer) can be implemented to understand and generate content, such as for translation and summarization. These examples are not intended to be limiting, and any architecture type-including but not limited to those described herein—can be implemented depending on the particular implementation and the task(s) being performed using the LLMs/VLMs/MMLMs/etc.

In various implementations, the LLMs/VLMs/MMLMs/etc. can be trained using unsupervised learning, in which an LLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 4A is a block diagram of an example generative language model system 400 suitable for use in implementing at least some implementations of the present disclosure. Generally, the example generative language model system 400 can generate labels, annotations, or associations across data inputs using structured learning processes. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which can include an LLM, a VLM, a multi-modal LM, etc.).

At a high level, the input processor 405 can receive an input 401 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 430 (e.g., LLM/VLM/MMLM/etc.). In some implementations, the input 401 includes plain text in the form of one or more sentences, paragraphs, and/or documents. Additionally or alternatively, the input 401 can include numerical sequences, precomputed embeddings (e.g., word or sentence embeddings), and/or structured data (e.g., in tabular formats, JSON, or XML). In some implementations in which the generative LM 430 is capable of processing multi-modal inputs, the input 401 can combine text (or can omit text) with image data, audio data, video data, design data, USD data, and/or other types of input data, such as but not limited to those described herein. Taking raw input text as an example, the input processor 405 can prepare raw input text in various ways. For example, the input processor 405 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 can remove stopwords to reduce noise and focus the generative LM 430 on more meaningful content. The input processor 405 can apply text normalization, for example, by converting all characters to lowercase, removing accents, and/or or handling special cases like contractions or abbreviations to ensure consistency. These are just a few examples, and other types of input processing can be applied.

In some implementations, a RAG component 492 (which can include one or more RAG models, and/or can be performed using the generative LM 430 itself) can be used to retrieve additional information to be used as part of the input 401 or prompt. RAG can be used to enhance the input to the LLM/VLM/MMLM/etc. with external knowledge, so that answers to specific questions or queries or requests are more relevant-such as in a case where specific knowledge is required. The RAG component 492 can fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some implementations, the input 401 can be generated using the query or input to the model (e.g., a question, a request, etc.) in addition to data retrieved using the RAG component 492. In some implementations, the input processor 405 can analyze the input 401 and communicate with the RAG component 492 (or the RAG component 492 can be part of the input processor 405, in implementations) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 can retrieve a prior stored conversation history—or at least a summary thereof—and include the prior conversation history along with the current ask/request as part of the input 401 to the generative LM 430.

The RAG component 492 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 492 and the embeddings of the chunks along with the embeddings of the query can be compared to identify the most similar/related embeddings to the query, which can be supplied to the generative LM 430 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/VLM/MMLM/etc. Rather than (or in addition to) providing the model with chunks of data extracted from larger sized documents—which can result in a lack of context, factual correctness, language accuracy, etc.—graph RAG can also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLM/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 492 can implement a plugin, API, user interface, and/or other functionality to perform RAG. For example, a graph RAG plug-in can be used by the LLM/VLM/MMLM/etc. to run queries against the knowledge graph to extract relevant information for feeding to the model, and a standard or vector RAG plug-in can be used to run queries against a vector database. For example, the graph database can interact with a plug-in's REST interface such that the graph database is decoupled from the vector database and/or the embeddings models.

The tokenizer 410 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy can depend on factors such as the language being processed, the task at hand, and/or characteristics of the training dataset. As such, the tokenizer 410 can convert the (e.g., processed) text into a structured format according to tokenization schema being implemented in the particular implementation.

The embedding component 420 can use any known embedding technique to transform discrete tokens into (e.g., dense, continuous vector) representations of semantic meaning. For example, the embedding component 420 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 401 can resize the data to a standard size compatible with format of a corresponding input channel and/or can normalize pixel values to a common range (e.g., 0 to 1) to ensure a consistent representation, and the embedding component 420 can encode the image data using any known technique (e.g., using one or more convolutional neural networks (CNNs) to extract visual features). In some implementations in which the input 401 includes audio data, the input processor 401 can resample an audio file to a consistent sampling rate for uniform processing, and the embedding component 420 can use any known technique to extract and encode audio features-such as in the form of a spectrogram (e.g., a mel-spectrogram). In some implementations in which the input 401 includes video data, the input processor 401 can extract frames or apply resizing to extracted frames, and the embedding component 420 can extract features such as optical flow embeddings or video embeddings and/or can encode temporal information or sequences of frames. In some implementations in which the input 401 includes multi-modal data, the embedding component 420 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 can apply an encoded representation of the input 401 to the generative LM 430, and the generative LM 430 can process the encoded representation of the input 401 to generate an output 490, which can include responsive text and/or other types of data.

As described herein, in some implementations, the generative LM 430 can be configured to access or use—or capable of accessing or using—plug-ins/APIs 495 (which can include one or more plug-ins, application programming interfaces (APIs), databases, data stores, repositories, etc.). For example, for certain tasks or operations that the generative LM 430 is not ideally suited for, the model can have instructions (e.g., as a result of training, and/or based on instructions in a given prompt, such as those retrieved using the RAG component 492) to access one or more plug-ins/APIs 495 (e.g., 3rd party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 495 to the plug-in/API 495, the plug-in/API 495 can process the information and return an answer to the generative LM 430, and the generative LM 430 can use the response to generate the output 490. This process can be repeated—e.g., recursively—for any number of iterations and using any number of plug-ins/APIs 495 until an output 490 that addresses each ask/question/request/process/operation/etc. from the input 401 can be generated. As such, the model(s) can not only rely on its own knowledge from training on a large dataset(s) and/or from data retrieved using the RAG component 492, but also on the expertise or optimized nature of one or more external resources-such as the plug-ins/APIs 495.

FIG. 4B is a block diagram of an example implementation in which the generative LM 430 includes a transformer encoder-decoder. Generally, the generative LM 430 can generate structured outputs, such as labels, associations, or data classifications, by processing input data through sequential modeling. For example, assume input text such as “Who discovered gravity” is tokenized (e.g., by the tokenizer410 of FIG. 4A) into tokens such as words, and each token is encoded (e.g., by the embedding component 420 of FIG. 4A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 440 can convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 can generate a first token, and the generation mechanism 455 can apply the generated token as an input during a second pass. The process can repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 can output some decoded (e.g., vector) representation of the input being applied during a particular pass. The classifier 450 can include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 can select or sample a word or token based on a corresponding predicted probability (e.g., select the word with the highest predicted probability) and append it to the output from a previous pass, generating each word or token sequentially. The generation mechanism 455 can repeat the process, triggering successive decoder inputs and corresponding predictions until selecting or sampling a symbol or token that represents the end of the response, at which point, the generation mechanism 455 can output the generated response.

FIG. 4C is a block diagram of an example implementation in which the generative LM 430 includes a decoder-only transformer architecture. For example, the decoder(s) 460 of FIG. 4C can operate similarly as the decoder(s) 445 of FIG. 4B except each of the decoder(s) 460 of FIG. 4C omits the encoder-decoder self-attention layer (since there is no encoder in this implementation). As such, the decoder(s) 460 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 460. As with the decoder(s) 445 of FIG. 4B, each token (e.g., word) can flow through a separate path in the decoder(s) 460, and the decoder(s) 460, a classifier 465, and a generation mechanism 470 can use auto-regression to sequentially generate one token at a time until predicting a symbol or token that represents the end of the response. The classifier 465 and the generation mechanism 470 can operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures can be implemented within the scope of the present disclosure.

### Example Computing Device

FIG. 5 is a block diagram of an example computing device(s) 500 suitable for use in implementing some implementations of the present disclosure. Generally, the example computing device(s) 500 can process data inputs to execute multi-object tracking tasks, generate label predictions, and refine associations across frames in accordance with a hierarchical model structure. Computing device 500 can include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one implementation, the computing device(s) 500 can comprise one or more virtual machines (VMs), and/or any of the components thereof can comprise virtual components (e.g., virtual hardware components). For non-limiting examples, one or more of the GPUs 508 can comprise one or more vGPUs, one or more of the CPUs 506 can comprise one or more vCPUs, and/or one or more of the logic units 520 can comprise one or more virtual logic units. As such, a computing device(s) 500 can include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some implementations, a presentation component 518, such as a display device, can be considered an I/O component 514 (e.g., if the display is a touch screen). As another example, the CPUs 506 and/or GPUs 508 can include memory (e.g., the memory 504 can be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 can represent one or more links or busses, such as an address bus, a data bus, a control bus, or a combination thereof. The interconnect system 502 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 506 can be directly connected to the memory 504. Further, the CPU 506 can be directly connected to the GPU 508. Where there is direct, or point-to-point connection between components, the interconnect system 502 can include a PCIe link to carry out the connection. In these examples, a PCI bus need not be included in the computing device 500.

The memory 504 can include any of a variety of computer-readable media. The computer-readable media can be any available media that can be accessed by the computing device 500. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 504 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 506 can be configured to execute at least some of the computer-readable instructions to control one or more components of the computing device 500 to perform one or more of the methods and/or processes described herein. The CPU(s) 506 can each include one or more cores (e.g., one, two, four, eight, twenty-eight, seventy-two, etc.) that are capable of handling a multitude of software threads simultaneously. The CPU(s) 506 can include any type of processor, and can include different types of processors depending on the type of computing device 500 implemented (e.g., processors with fewer cores for mobile devices and processors with more cores for servers). For example, depending on the type of computing device 500, the processor can be an Advanced RISC Machines (ARM) processor implemented using Reduced Instruction Set Computing (RISC) or an x86 processor implemented using Complex Instruction Set Computing (CISC). The computing device 500 can include one or more CPUs 506 in addition to one or more microprocessors or supplementary co-processors, such as math co-processors.

In addition to or alternatively from the CPU(s) 506, the GPU(s) 508 can be configured to execute at least some of the computer-readable instructions to control one or more components of the computing device 500 to perform one or more of the methods and/or processes described herein. One or more of the GPU(s) 508 can be an integrated GPU (e.g., with one or more of the CPU(s) 506 and/or one or more of the GPU(s) 508 can be a discrete GPU. In implementations, one or more of the GPU(s) 508 can be a coprocessor of one or more of the CPU(s) 506. The GPU(s) 508 can be used by the computing device 500 to render graphics (e.g., 3D graphics) or perform general purpose computations. For example, the GPU(s) 508 can be used for General-Purpose computing on GPUs (GPGPU). The GPU(s) 508 can include hundreds or thousands of cores that are capable of handling hundreds or thousands of software threads simultaneously. The GPU(s) 508 can generate pixel data for output images in response to rendering commands (e.g., rendering commands from the CPU(s) 506 received via a host interface). The GPU(s) 508 can include graphics memory, such as display memory, for storing pixel data or any other suitable data, such as GPGPU data. The display memory can be included as part of the memory 504. The GPU(s) 508 can include two or more GPUs operating in parallel (e.g., via a link). The link can directly connect the GPUs (e.g., using NVLINK) or can connect the GPUs through a switch (e.g., using NVSwitch). When combined together, each GPU 508 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 506 and/or the GPU(s) 508, the logic unit(s) 520 can be configured to execute at least some of the computer-readable instructions to control one or more components of the computing device 500 to perform one or more of the methods and/or processes described herein. In implementations, the CPU(s) 506, the GPU(s) 508, and/or the logic unit(s) 520 can discretely or jointly perform any combination of the methods, processes and/or portions thereof. One or more of the logic units 520 can be part of and/or integrated in one or more of the CPU(s) 506 and/or the GPU(s) 508 and/or one or more of the logic units 520 can be discrete components or otherwise external to the CPU(s) 506 and/or the GPU(s) 508. In implementations, one or more of the logic units 520 can be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 can include one or more receivers, transmitters, and/or transceivers that allow the computing device 500 to communicate with other computing devices via an electronic communication network, included wired and/or wireless communications. The communication interface 510 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 520 and/or communication interface 510 can include one or more data processing units (DPUs) to transmit data received over a network and/or through interconnect system 502 directly to (e.g., a memory of) one or more GPU(s) 508.

The I/O ports 512 can allow the computing device 500 to be logically coupled to other devices including the I/O components 514, the presentation component(s) 518, and/or other components, some of which can be built in to (e.g., integrated in) the computing device 500. Illustrative I/O components 514 include a microphone, mouse, keyboard, joystick, game pad, game controller, satellite dish, scanner, printer, wireless device, etc. The I/O components 514 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 can be include depth cameras, such as stereoscopic camera systems, infrared camera systems, RGB camera systems, touchscreen technology, and combinations of these, for gesture detection and recognition. Additionally, the computing device 500 can include accelerometers or gyroscopes (e.g., as part of an inertia measurement unit (IMU)) that allow detection of motion. In some examples, the output of the accelerometers or gyroscopes can be used by the computing device 500 to render immersive augmented reality or virtual reality.

The power supply 516 can include a hard-wired power supply, a battery power supply, or a combination thereof. The power supply 516 can provide power to the computing device 500 to allow the components of the computing device 500 to operate.

The presentation component(s) 518 can include a display (e.g., a monitor, a touch screen, a television screen, a heads-up-display (HUD), other display types, or a combination thereof), speakers, and/or other presentation components. The presentation component(s) 518 can receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that can be used in at least one implementations of the present disclosure. Generally, the example data center 600 can support large-scale processing, storage, and training of multi-object tracking models. The data center 600 can include a data center infrastructure layer 610, a framework layer 620, a software layer 630, and/or an application layer 640.

As shown in FIG. 6, the data center infrastructure layer 610 can include a resource orchestrator 612, grouped computing resources 614, and node computing resources (“node C.R.s”) 616(1)-616(N), where “N” represents any whole, positive integer. In at least one implementation, node C.R.s 616(1)-616(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 616(1)-616 (N) can correspond to a server having one or more of the above-mentioned computing resources. In addition, in some implementations, the node C.R.s 616(1)-6161(N) can include one or more virtual components, such as vGPUs, vCPUs, and/or the like, and/or one or more of the node C.R.s 616(1)-616(N) can correspond to a virtual machine (VM).

In at least one implementation, grouped computing resources 614 can include separate groupings of node C.R.s 616 housed within one or more racks (not shown), or many racks housed in data centers at various geographical locations (also not shown). Separate groupings of node C.R.s 616 within grouped computing resources 614 can include grouped compute, network, memory or storage resources that can be configured or allocated to support one or more workloads. In at least one implementation, several node C.R.s 616 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 612 can configure or otherwise control one or more node C.R.s 616(1)-616(N) and/or grouped computing resources 614. In at least one implementation, resource orchestrator 612 can include a software design infrastructure (SDI) management entity for the data center 600. The resource orchestrator 612 can include hardware, software, or some combination thereof.

In at least one implementation, as shown in FIG. 6, framework layer 620 can include a job scheduler 628, a configuration manager 634, a resource manager 636, and/or a distributed file system 638. The framework layer 620 can include a framework to support software 632 of software layer 630 and/or one or more application(s) 642 of application layer 640. The software 632 or application(s) 642 can respectively include web-based service software or applications, such as those provided by Amazon Web Services, Google Cloud and Microsoft Azure. The framework layer 620 can be, but is not limited to, a type of free and open-source software web application framework such as Apache Spark™ (hereinafter “Spark”) that can use distributed file system 638 for large-scale data processing (e.g., “big data”). In at least one implementation, job scheduler 628 can include a Spark driver to facilitate scheduling of workloads supported by various layers of data center 600. The configuration manager 634 can be capable of configuring different layers such as software layer 630 and framework layer 620 including Spark and distributed file system 638 for supporting large-scale data processing. The resource manager 636 can be capable of managing clustered or grouped computing resources mapped to or allocated for support of distributed file system 638 and job scheduler 628. In at least one implementation, clustered or grouped computing resources can include grouped computing resource 614 at data center infrastructure layer 610. The resource manager 636 can coordinate with resource orchestrator 612 to manage these mapped or allocated computing resources.

In at least one implementation, software 632 included in software layer 630 can include software used by at least portions of node C.R.s 616(1)-616(N), grouped computing resources 614, and/or distributed file system 638 of framework layer 620. One or more types of software can include, but are not limited to, Internet web page search software, e-mail virus scan software, database software, and streaming video content software.

In at least one implementation, application(s) 642 included in application layer 640 can include one or more types of applications used by at least portions of node C.R.s 616(1)-616(N), grouped computing resources 614, and/or distributed file system 638 of framework layer 620. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 634, resource manager 636, and resource orchestrator 612 can implement any number and type of self-modifying actions based on any amount and type of data acquired in any technically feasible fashion. Self-modifying actions can relieve a data center operator of data center 600 from making possibly bad configuration decisions and possibly avoiding underutilized and/or poor performing portions of a data center.

The data center 600 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 600. In at least one implementation, trained or deployed machine learning models corresponding to one or more neural networks can be used to infer or predict information using resources described above with respect to the data center 600 by using weight parameters calculated through one or more training techniques, such as but not limited to those described herein.

In at least one implementation, the data center 600 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 500 of FIG. 5—e.g., each device can include similar components, features, and/or functionality of the computing device(s) 500. In addition, where backend devices (e.g., servers, NAS, etc.) are implemented, the backend devices can be included as part of a data center 600, an example of which is described in more detail herein with respect to FIG. 6.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 500 described herein with respect to FIG. 5. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
update a graph neural network based at least on video data representing a plurality of first objects and a plurality of first labels corresponding to the plurality of first objects;
cause the graph neural network to generate a plurality of second labels of a first example video and update the graph neural network based at least on the plurality of second labels and the first example video;
cause the graph neural network to generate a plurality of third labels of a second example video, wherein at least one third label of the plurality of third labels corresponds to an uncertainty score; and
output a request for a modification to the at least one third label responsive to the uncertainty score satisfying an annotation criterion.

2. The one or more processors of claim 1, wherein the plurality of second labels correspond to one or more predicted associations between a plurality of second objects in a plurality of frames of the first example video.

3. The one or more processors of claim 1, wherein the plurality of third labels correspond to one or more predicted associations between a plurality of third objects across a plurality of frames of the second example video.

4. The one or more processors of claim 3, wherein the graph neural network is configured to generate a graph representation of the second example video comprising a plurality of nodes and a plurality of edges.

5. The one or more processors of claim 4, wherein the plurality of nodes represent a plurality of detections of the plurality of third objects across the plurality of frames and the plurality of edges represent the one or more predicted associations, and wherein at least one edge of the plurality of edges is associated with at least one corresponding label of the plurality of third labels.

6. The one or more processors of claim 5, wherein the request for modification comprises a plurality of selectable actions for modifying the at least one third label, the plurality of selectable actions comprise at least one of:
an action to confirm a validity of at least one of the one or more predicted associations between at least two detections of the plurality of detections;
an action to remove at least one detection of the plurality of detections;
an action to modify one or more spatial boundaries of a bounding box of the at least one detection; or
an action to associate the at least one detection in a first frame of the plurality of frames to another detection in a second frame of the plurality of frames.

7. The one or more processors of claim 3, wherein the uncertainty score of the plurality of third labels is based at least entropy or at least one probabilistic metric derived from an output of the graph neural network, wherein the entropy corresponds to a measure of uncertainty in the one or more predicted associations of the plurality of third objects across the plurality of frames.

8. The one or more processors of claim 1, wherein the video data comprises a plurality of synthetic data samples corresponding to a plurality of simulated trajectories of the plurality of first objects in a plurality of environments, wherein updating the graph neural network comprises using the plurality of synthetic data samples to pre-train the graph neural network to generate the plurality of second labels of the first example video.

9. The one or more processors of claim 1, wherein the annotation criterion corresponds to a threshold for selecting a subset of the plurality of third labels having corresponding uncertainty scores satisfying the threshold.

10. The one or more processors of claim 1, wherein the graph neural network comprises a hierarchical structure configured to model a plurality of detection candidates, wherein a first level of the hierarchical structure comprises generating at least one label for at least one detection candidate of the plurality of detection candidates, and wherein one or more subsequent levels of the hierarchical structure comprises generating at least one label for one or more predicted associations between the plurality of detection candidates.

11. The one or more processors of claim 1, wherein the video data comprises data captured using a plurality of cameras positioned in an environment, and wherein the graph neural network comprises performing a two-dimensional (2D) to three-dimensional (3D) transformation on the second example video.

12. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

13. A system, comprising:
one or more processors to execute operations comprising:
update a graph neural network based at least on video data representing a plurality of first objects and a plurality of first labels corresponding to the plurality of first objects;
cause the graph neural network to generate a plurality of second labels of a first example video and update the graph neural network based at least on the plurality of second labels and the first example video;
cause the graph neural network to generate a plurality of third labels of a second example video, wherein at least one third label of the plurality of third labels correspond to an uncertainty value; and
output a request for a modification to the at least one third label responsive to the uncertainty value satisfying an annotation criterion.

14. The system of claim 13, wherein the plurality of second labels correspond to one or more predicted associations between a plurality of second objects in a plurality of frames of the first example video.

15. The system of claim 13, wherein the plurality of third labels correspond to one or more predicted associations between a plurality of third objects across a plurality of frames of the second example video.

16. The system of claim 15, wherein the graph neural network is configured to generate a graph representation of the second example video comprising a plurality of nodes and a plurality of edges.

17. The system of claim 16, wherein the plurality of nodes represent a plurality of detections of the plurality of third objects across the plurality of frames and the plurality of edges represent the one or more predicted associations, and wherein at least one edge of the plurality of edges is associated with a corresponding label of the plurality of third labels.

18. The system of claim 17, wherein the request for modification comprises a plurality of selectable actions for modifying the at least one third label, the plurality of selectable actions comprising at least one of:
one or more actions to confirm a validity of at least one of the one or more predicted associations between at least two detections of the plurality of detections;
one or more actions to remove at least one detection of the plurality of detections;
one or more actions to modify one or more spatial boundaries of a bounding box of the at least one detection; or
one or more actions to associate the at least one detection in a first frame of the plurality of frames to another detection in a second frame of the plurality of frames.

19. The system of claim 14, wherein the uncertainty value of the plurality of third labels is based at least on an entropy value or at least one probabilistic metric derived from an output of the graph neural network, wherein the entropy value corresponds to a measure of uncertainty in the one or more predicted associations of the plurality of third objects across the plurality of frames.

20. A method, comprising:
updating, using one or more processors, a graph neural network based at least on video data representing a plurality of first objects and a plurality of first labels corresponding to the plurality of first objects;
causing, using the one or more processors, the graph neural network to generate a plurality of second labels of a first example video and update the graph neural network based at least on the plurality of second labels and the first example video;
causing, using the one or more processors, the graph neural network to generate a plurality of third labels of a second example video, wherein at least one third label of the plurality of third labels corresponds to an uncertainty value; and
outputting, using the one or more processors, a request for a modification to the at least one third label responsive to the uncertainty value satisfying an annotation criterion.
